(19) United States
(12) Patent Application Publication
(10) Pub. No.: US 2026/0003650 A1
(43) Pub. Date: Jan. 1, 2026

(54) TASK AUTOMATION

(71) Applicant: Amazon Technologies, Inc., Seattle, WA (US)

(72) Inventors: Rajesh Goli, Fremont, CA (US); Kirti Shrinkhala, Seattle, WA (US); Sriram Devanathan, Redmond, WA (US); Anil Kumar Chitturi, Redmond, WA (US); Venkata Rao Pedapati, Surrey (CA)

(21) Appl. No.: 18/759,094

(22) Filed: Jun. 28, 2024

(51) Int. Cl. G06F 9/451; G06F 40/284

(52) U.S. Cl. CPC G06F 9/451; G06F 40/284

(57) ABSTRACT

Systems and methods are described for automating the performance of a task on behalf of a user that the user would otherwise perform manually or semi-manually. In order to automate the task, a user can provide a task automation system with a description of the steps the user would implement in order to perform the task manually. The description of the steps can be provided to the task automation system as multi-modal input. The task automation system may convert the multi-modal input into tokens and input the tokens to an AI model trained to generate a workflow description. The task automation system may later generate instructions using an AI model based on the workflow description and annotations of the application used to perform the task. The task automation system may then implement the instructions generated by the AI model to perform the task automatically on behalf of the user.

### BACKGROUND

A user may wish to leverage an artificial intelligence (“AI”) model to perform tasks on their behalf using a computing system. AI models can receive multiple types of information as input, and output a result based on that input and what the AI model is trained to do. Accordingly, a user of a computing system may provide some input to an AI model, such as a large language model or “LLM,” and the AI model, may generate output that is itself, the result of the task to be performed on behalf of the user, or that can be used by another computer-implement application to perform the task (or a portion thereof) requested by the user. In such examples, the user may create an application programming interface (“API”) connector, which connects to the application's underlying APIs in order to enable the application to perform the task requested by the user.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 depicts an example computing environment in which a task automation system including a configuration building application and a runtime application can process user input describing steps to perform a task on behalf of a user; generate, from the user input, programmatic instructions to perform the task automatically rather than manually; and execute the set of instructions to automatically perform the task.

FIG. 2 depicts an example routine implemented by the task automation system in order to generate the workflow description to perform the task automatically.

FIG. 3 depicts an example routine implemented by the task automation system for executing the programmatic instructions to automatically perform the task.

FIGS. 4 and 5 depict an example use case in which the task automation system is used to automate a task of filling out a form presented in a user interface which the user may use to perform the task to be automated.

FIG. 6 depicts a general architecture of a computing device capable of implementing the task automation system described herein.

### DETAILED DESCRIPTION

Generally, aspects of the present disclosure relate to automating a task on behalf of a user that the user would otherwise perform manually or semi-manually. For example, such a task may be filling out a form presented in a user interface (“UI”) with data received from another data source such as an email or text message. Rather than transferring the data from the data source manually, e.g., by manually copying data from an email into individual fields of the form, a user may request a task automation system formed in accordance with the present disclosure with data copied from an email the user has received. Such a task, when performed automatically, without human intervention, can provide significant time and computing resources (e.g., storage and computational) savings, particularly when a task is to be performed repeatedly and with a high volume. In order to automate the task, a user can provide the task automation system with a description of the steps the user would implement in order to perform the task manually (e.g., where all of the steps are implemented or initiated by the user as opposed to a computer) or semi-manually (e.g., where a subset of the steps are implemented or initiated by the user and some by a computer). The description of the steps can be input to the task automation system by the user in a number of ways, e.g., via language, audio and/or visual, using a variety of input modalities, e.g., pointing devices (mouse, pen tablet, light pen, touch screen, data glove, etc.), keyboard (e.g., American Standard Code for Information Interchange (“ASCII”), numeric keypad, cursor keys, Musical Instrument Digital Interface (“MIDI”), etc.), microphone, camera, and other language, visual and auditory sensors. Such input may be referred to as “multi-modal input” and can describe the steps of the task the user is requesting the task automation system to automate. As will be described in more detail below, the task automation system may then convert the multi-modal input into tokens and input the tokens to an AI model in order to generate a workflow description. The task automation system may then input the workflow description, new data received by the task automation system related to the task, and annotations of the application used to perform the task to the AI model in order to generate programmatic instructions, which the task automation system may later implement or execute to perform the task automatically on behalf of the user. The programmatic instructions may include a specific set of instructions that describe how to programmatically implement the workflow described in the workflow description.

The term “model” or “AI model,” as used in the present disclosure, can include any computer-based model of any type and of any level of complexity, such as any type of sequential, functional, or concurrent model. Models can further include various types of computational models, such as, for example, artificial neural networks (“NN”), convolutional neural networks (“CNNs”), language models (e.g., large language models (“LLMs ”)), machine learning (“ML”) models, multimodal models (e.g., models or combinations of models that can accept multi-modal input.

Existing AI models may be susceptible to hallucinations and other errors that can lead to outputs that include false or misleading information. Variations in the input to AI models can also yield variations in the quality and consistency of the output generated by the model. Therefore, utilizing an AI model to automate tasks may have limited accuracy. For example, asking an AI model to perform a task without sufficient input may lead to the AI model outputting incorrect or imperfect instructions to perform the task. In addition, using an AI model to generate instructions for automating a task may also require a user to connect a computer-implemented application utilized to perform the task with the AI model. However, such connectors integrate with the underlying APIs of the computer-implemented application. This may require the user building the connector to be familiar with the underlying API infrastructure. Therefore, a user that is not familiar with the underlying APIs' infrastructure may be limited in their ability to leverage the AI model to automate the task.

In order to improve the accuracy of the AI model output and leverage the AI model to automate the task, the task automation system can accept robust, multi-modal input from the user that describes the steps to perform a task and can ultimately provide the AI model with input sufficient to enable the AI model to understand both the high level goals of the user the and granular actions the user might perform to reach those goals. The AI model can then output a workflow description of how to automatically perform the task. The task automation system can also annotate fields in a user interface, information for which can be input to the AI model, along with the workflow description and any new data received by the task automation system relevant to performing the task, to generate programmatic instructions incorporating the annotated fields and accomplish the goal of the user with higher accuracy and a lower error rate. Once the AI model has generated the programmatic instructions, the task automation system can execute them in connection with a computer-implemented application at runtime in order to automatically perform the task. However, in some examples, in order to further improve accuracy, the workflow description may be presented to the user, e.g., via a UI presented at the user's device, for review and further configuration by the user prior to execution, as will be described in more detail below.

The task automation system described herein may also address problems associated with building connectors to the underlying APIs of the computer-implemented applications utilized to perform the task by including, within the programmatic instructions the AI model generates, the instructions for integrating with the underlying APIs of the computer-implemented applications. Accordingly, the user need only describe the goal of connecting the AI model to a computer-implemented application without the user (who may not be familiar with the underlying API infrastructure) having to build a connector themselves. The task automation system described herein also enables integration with traditional/legacy systems that do not have a well-defined API with which to integrate. For example, if a user wants to create a ticket using a particular system or application, this can be done by generating instructions to implement certain actions via a UI presented by the system or application instead of integrating with the APIs of the system or application.

In a specific example, the task automation system can receive a request to automate the task of repeatedly filling out a form included in a UI (such as a webpage) presented by a computer-implemented application (such as a web browser), with data the user has received from numerous email messages. More specifically, the HyperText Markup Language (“HTML”) of the webpage with which a user would interact can be input to a LLM along with multi-modal input from the user describing the steps the user would like the task automation system to take to fill out the various fields of the form with data found in the emails received by the user. The multi-modal input may include, e.g., a recorded, natural language narration by the user of the steps and an image of the webpage including the form. The task automation system may then convert the multi-modal input into tokens and input the tokens to an AI model to generate a workflow description describing the steps taken to fill out the form in the UI.

The task automation system may be further configured to translate the workflow description to programmatic instructions prior to execution by incorporating actionable items (e.g., fields, buttons, etc.), as identified through annotation, in the computer-implemented application(s) involved in performing the task since generating the workflow description. At runtime, the task automation system can annotate fields in a user interface of the computer-implemented application with references to input elements of the user interface, which annotated fields can be input to the AI model, along with the workflow description and any new data received by the task automation system relevant to performing the task, to generate programmatic instructions incorporating the annotated fields. Referring to the form-filling example, prior to generating the programmatic instructions to fill out the form, the task automation system can annotate the form to identify any fields, convert the annotations, new data (e.g., data the user has received from a new email message), and workflow description into tokens, and input the tokens to the AI model. The AI model may then generate programmatic instructions, which the task automation system can then execute to automatically fill out the form.

The task automation system may later execute the programmatic instructions to launch the web browser, present the webpage, and fill out the form included in the webpage automatically, without the user's intervention. Therefore, rather than the user manually copying and pasting data from an email into the fields of the form, the programmatic instructions generated and output by the LLM are executed to automatically extract from the email the data relevant to the fields of the form and enter the data to the fields of the form. The programmatic instructions may further include instructions to submit the data entered into the form to a backend server or other system for further processing and/or storage via an API and discard the email therefore saving storage resources.

In other examples, the task automation system may generate programmatic instructions with the AI model related to UI elements other than or in addition to data entry fields. Such UI elements may include widgets such as buttons, scroll bars, radio buttons, dropdown menus, checkboxes, toggles, navigational controls, breadcrumbs, icons, etc., or a combination thereof. A widget can display content, take in input, connect to other widgets, and create output. Widgets that take in input allow users to interact with a computer-implemented application. Widgets that create output use prompts and references to other widgets to generate something like an image or text. There may be multiple types of widgets, such as AI-powered widgets which include image generation, chatbot, and text generation. Other widgets may include user input and static text.

Once the programmatic instructions have been generated, it may be executed by the task automation system at a later time to automatically perform the task on behalf of the user. Such later time may be referred to as “runtime” and the programmatic instructions may be executed at runtime in response to a request or in response to a triggering event. Referring to the form-filling example, the user may have requested, and the task automation system may have generated, programmatic instructions to automatically process emails received by the user as the emails are received. Accordingly, the triggering event may be the receipt of such an email, in which case when each such an email is received, the task automation system may execute the programmatic instructions to launch the web browser, display the web page including the form, extract from the email the data relevant to the fields of the form, enter the data to the fields of the form, and so on. Alternatively, the user may have requested, and the task automation system may have generated, programmatic instructions to automatically process emails received by the users in batches when requested by the user.

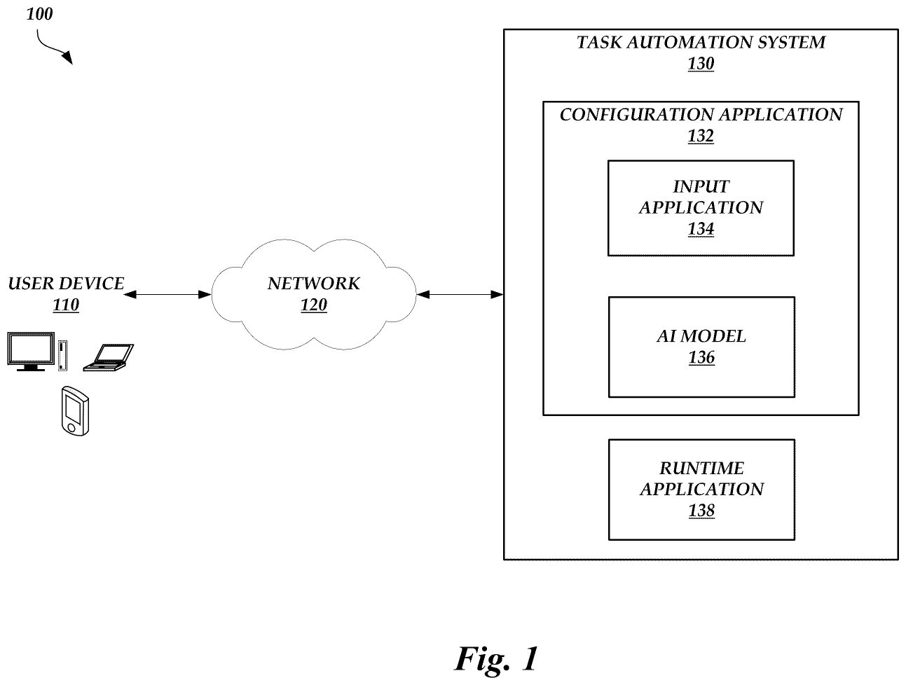

Referring now to the figures, FIG. 1 depicts an example computing environment 100 in which a task automation system 130 receives, via a network 120, a request from a user device 110 to automate a task. Although FIG. 1 depicts an example in which the task automation system 130 receives the request via a network, in other examples, the task automation system 130 (or components thereof) is co-located on the user device 110. A user device(s) 110 may be any computing device with which a user may interact with the task automation system 130. For example, the user device 110 may be a desktop, tablet, e-reader, server, wearable device, laptop or tablet computer, smartphone, gaming console, personal digital assistant (PDA), hybrid PDA/mobile phone, mobile phone, electronic book reader, set-top box, voice command device, camera, digital media player, and the like.

The network 120 can include any appropriate network, including wired network, wireless network, or combination thereof. For example, the network 120 may be a personal area network, local area network, wide area network, cable network, satellite network, cellular network, or any other such network or combination thereof. As a further example, the network 120 may be a publicly accessible network of linked networks, possibly operated by various distinct parties, such as the Internet. Protocols and components for communicating via the Internet or any other types of communication networks are known to those skilled in the art of computer communications, and thus, need not be described in more detail herein. In various embodiments, the network 120 may be a private or semi-private network, such as a corporate or university intranet. The network 120 may include one or more wireless networks, such as a Global System for Mobile Communications (GSM) network, a Code Division Multiple Access (CDMA) network, a Long-Term Evolution (LTE) network, C-band, mmWave, sub-6GHZ, or any other type of wireless network. The network 120 can use protocols and components for communicating via the Internet or any of the other aforementioned types of networks. For example, the protocols used by the network 120 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications, and thus, need not be described in more detail herein.

The task automation system 130 may include a configuration application 132 and a runtime application 138. The configuration application 132 may receive a request to automate a task associated with a user interface. The request may originate from the user device 110 and may be sent via the network 120. The configuration application 132 may also receive multimodal input from the user device 110 via the network 120 indicating how to perform the task associated with the user interface. The configuration application 132 may further generate a workflow description of how to perform the task. The runtime application 138 may generate and execute programmatic instructions in response to a request from the user, another computing device, or another computer-implemented application, or may generate and execute the programmatic instructions in response to a triggering event.

The configuration application 132 may include an input application 134 and an AI model 136. The input application 134 may include an automated chatbot application that can communicate with the requesting user in order to receive the user request to automate the task. For example, the input application 134 may generate an interactive UI for presentation on the user device 110 into which the user may type or otherwise input answers to questions, a description of steps to perform, etc. and the input application 134 can respond to the user's questions or requests. The input application 134 may further receive or capture multimodal input describing the steps the user wishes the task automation system 130 to take to automate the task. For example, in the form-filling use case mentioned above, the input application 134 may conduct a screen recording to capture the user's interactions with the form while the user fills out the form manually and may conduct an audio recording the user's audio narration of how to fill out the form. The multimodal input may further include the user input and actions (e.g., computer clicks, interaction with a field in a UI, pixel coordinates for user interactions, etc.) that may be a part of the recording described above. Accordingly, the multimodal input may include the screen recording, the audio recording, the user textual input, user UI interactions, and the like.

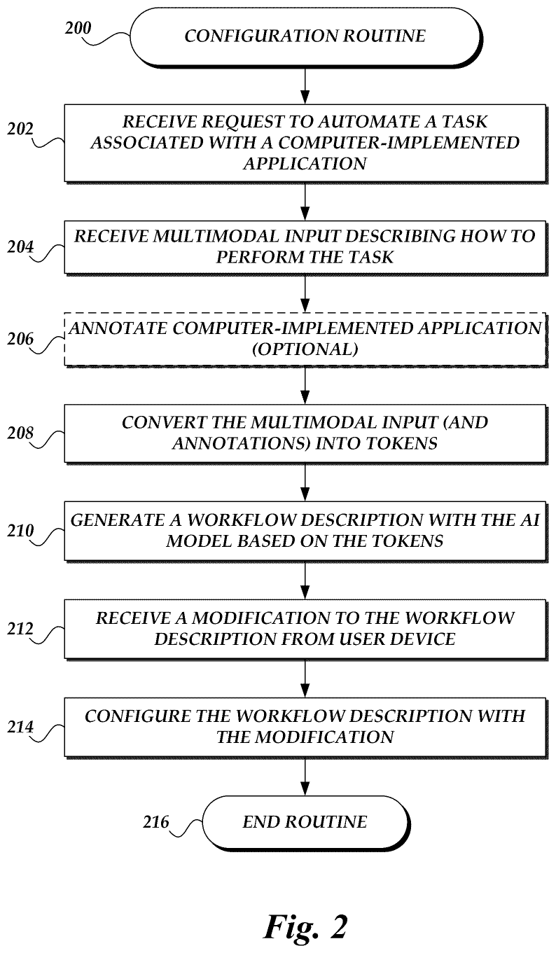

The input application 134 may further convert the multi-modal input into tokens understandable to the AI model 136. A token may be a unit of data that is understandable to the AI model 136. Tokens can include characters, letters, parts of words, a word, and/or a phrase. The tokenization process will be described in further detail below with respect to FIG. 2.

The AI model 136 may receive as input the tokens from the input application 134 and generate a workflow description of how to perform the task automatically based on the tokens. The AI model 136 may translate the workflow description into programmatic instructions at runtime. In one example, the AI model 136 is an LLM; however, in other examples, the task automation system 130 may use another type of AI model or combination of AI models as described above. In the case of the AI model 136 being an LLM, the input application 134 may have the LLM generate the workflow description by providing the LLM with a prompt asking the LLM to generate the workflow description. Similarly, the input application 134 may have the LLM generate the programmatic instructions by providing the LLM with a prompt asking the LLM to generate the programmatic instructions.

Furthermore, the input application 134 may optionally receive configuration modification(s) s from the user device 110 to the workflow description following output from the AI model 136 but prior to runtime. The input application 134 can update or otherwise modify the workflow description according to the configuration modifications from the user device 110. The input application 134 may generate an interactive UI for presentation on the user device 110 in which the user can view the workflow description output by the AI model 136 and make modification(s) to the workflow description. The runtime application 138 may then generate and execute programmatic instructions based on the modified workflow description in order to further improve runtime accuracy. The runtime application 138 can initiate generation and execution of the programmatic instructions in response to a request or a triggering event.

The runtime application 138 may further annotate information of a user interface used to perform the task prior to execution in order to incorporate actionable fields in the computer-implemented application involved in performing the task, by including reference points for specific user interface elements as annotations for the information. For example, the runtime application 138 may identify the actionable fields in a user interface of the computer-implemented application(s) involved in performing the task, and annotate such actionable fields with reference points that provide for unambiguous identification of those fields. Accordingly, the runtime application 138 may launch the computer-implemented application involved in performing the task, and annotate UI elements detected in the application. Advantageously, the use of reference points can enable a subsequent AI model to unambiguously refer to specific fields, such that instructions output by the AI model can be programmatically implemented. For example, an LLM, by default, may output instructions for implementing a task in a format that is human-comprehensible but difficult for a machine to implement (e.g., “click the button in the top left of the interface”). By use of annotations, a model may instead output machine implementable instructions. For example, where the annotations correspond to screen coordinates for an input field, an LLM may output instructions to navigate a cursor to the screen coordinates and input specific data. These instructions may then be implemented by the runtime application 138 (e.g., via automation software) to execute the task. Thus, annotations as described herein can enable more accurate generation of instructions by an AI model, such as an LLM.

As discussed above, the runtime application 138 may use the annotations and workflow description to generate programmatic instructions to automatically perform the task, such as with respect to new input data. For example, when obtaining new input data, the runtime application 138 may pass the new input data, the workflow description, and annotated information of a user interface to an AI model trained to generate instructions for implementing the task on the user interface with the new input data. The AI model may then generate instructions to programmatically perform the task. Illustratively, the instructions may include instructions to input at least a portion of the new input data into the at least one user interface element using a programmatic reference point for the at least one user interface element included within the annotations. These instructions may then be implemented by the runtime application 138, such as by using automation software to implement the instructions. Accordingly, the previously manual task may be programmatically automated.

Referring again to the form-filling use case as an example, at runtime the runtime application 138 may identify HTML elements of the webpage generated by the web browser application. For example, the form included in the webpage may contain fields, such as fields for a name, an email address, and a phone number. Therefore, the runtime application 138 can annotate the fields for name, email, and phone number to indicate an interaction with those fields is needed to perform the task of filling out the form automatically and utilize the input application 134 to convert the annotations, any new data received by the task automation system 130, and prior instructions into tokens.

Once the conversion is conducted, the runtime application 138 can input the tokens to the AI model 136. The AI model 136 may then generate and output programmatic instructions incorporating the fields, where the AI model 136 is transforming the workflow description into programmatic instructions with respect to specific elements based on the annotations. The programmatic instructions may further include instructions for extracting the data corresponding to the fields entering the data to the fields. Accordingly, when the runtime application 138 executes the programmatic instructions, the runtime application can manipulate the specific elements indicated in the programmatic instructions, such as filling in the fields with the data extracted from the email.

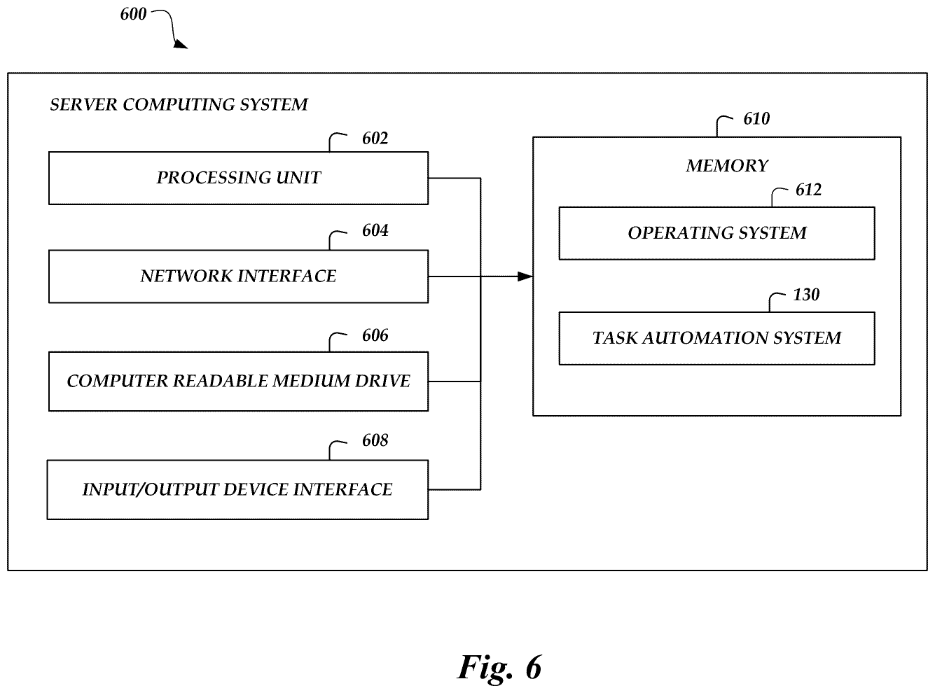

The task automation system 130 can be implemented on computing systems (such as server computing system 600 depicted in FIG. 6), or alternatively, on a cloud provider network that can be accessed by the user device 110 over the network 120. A cloud provider network (sometimes referred to simply as a “cloud”), refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

The cloud provider network can include sets of host computing devices, where each set can represent a logical group of devices, such as a physical “rack” of devices. Each computing device can support one or more hosted machine instances that may be virtual machine instances, representing virtualized hardware supporting, e.g., an operating system and applications. Hosted machine instances may further represent “bare metal” instances, whereby a portion of the computing resources of the computing device directly support (without virtualization) the machine instance. In some cases, a machine instance may be created and maintained on behalf of a client. For example, a client may utilize a client computing device to request creation of a machine instance executing client-defined software. In other cases, machine instances may implement functionality of the cloud provider network itself. For example, machine instances may correspond to block storage servers, object storage servers, or compute servers that in term provide block storage, object storage, or compute, respectively, to client computing devices.

FIG. 2 depicts an example configuration routine 200 performed by the configuration application 132 described above in order to generate a workflow description to perform a task automatically. First, at block 202, the configuration application 132 may receive a request to automate a task associated with a computer-implemented application. The request may indicate a desire to automate a task associated with a computer-implemented application. For example, the computer-implemented application may be a web browser that generates a webpage including an electronic form or an interactive spreadsheet. In the case of an electronic form, the task to be automated may include filling out the form with text from another source, such as an email, text message, voicemail, etc. In the case of an interactive spreadsheet, the task to be automated may include filtering the data in the spreadsheet and conducting statistical analysis on the filtered data. It will be appreciated that the foregoing examples are for illustrative purposes only and not intended to be limiting.

A user may interact with the configuration application 132 via the user device 110 to send the request. More specifically, the user may interact with the input application 134. The input application 134 may have an option to enter the request using a text box. For example, the user may send the request by including a message in a chat box to the input application 134 indicating a desire to automate the task. The user may use the user device 110 to enter the input application 134 interface and type a message to the input application 134 requesting automation. The input application 134 may additionally respond to the request to ask further follow up questions to the user or confirm receipt of the request.

At block 204, the configuration application 132 may receive multimodal input describing how to perform the task. For example, the configuration application 132 may receive the input via the input application 134. The input application 134 may receive input from the user device 110 that indicates how to perform the task associated with the user interface. The input may come in multiple forms, such as a screen recording, audio narration, text transcription, or textual description where the user can describe the task that they wish to perform. For example, the user may share their screen while they perform the task and the input application 134 may record the screen as the user performs the task. From the screen recording, the input application 134 may detect user interactions with the user interface. For example, the input application 134 may detect user interactions with Document Object Model (DOM), HTML, JavaScript, Cascading Style Sheet (“CSS”), Extensible Markup Language (“XML”) or other elements in a webpage, or, for non-web-based applications, detected user interactions may include capturing mouse/cursor coordinates (e.g., in pixels), document markers (e.g., paragraph markers, boundary markers, styling properties, etc.) or the like to see where a user is interacting, using edge detection or other visual recognition models to classify a particular input element in the UI corresponding to that cursor. The user may also narrate the steps they perform in order to perform the task. The narration may occur while the user is interacting with what is displayed on their screen. The user interactions may also be shared with the input application 134 as a form of multimodal input.

At block 206, the configuration application 132 may optionally annotate the computer-implemented application. An annotation may provide an unambiguous reference point for an individual field that is conducted to perform the task associated with the user interface. Annotating the fields may include labeling fields of the form and other widgets in the webpage with unambiguous labels (e.g., unique numerals). Referring to the form-filling use case mentioned above as an example, the multimodal input may identify the fields in the form into which the user wishes data from an email to be entered, as well as any other widgets, such as buttons, navigational controls, etc., and label such fields for later unambiguous reference. For example, the screen recording may depict the user entering a name into a “Name” field in the form and the audio recording may capture the user narrating “I enter the email sender's name into the ‘Name’ box in the form” as the user enters the name. An annotation may provide an unambiguous label for the field, such as a reference numeral, particular DOM object, particular screen coordinates, or the like. Such annotations can later be used to unambiguously refer to user interface elements.

At block 208, the configuration application 132 may convert the received multimodal input (and optional annotations) into tokens understandable by the AI model 136. The AI model 136 may not be able to process certain forms of input, such as fields, screen recordings, audio narrations, text transcriptions, textual descriptions, and the like. Instead, in order to allow the AI model 136 to understand the input, the input can be converted into tokens that the AI model 136 can process. A token may be a unit of data corresponding to input that is understandable to the AI model 136. Tokens can include characters, letters, parts of words, a word, and/or a phrase. Tokenizing the input may split the input into smaller units of data that the AI model 136 can understand. A single input may correspond to multiple tokens. The token can represent a word, phrase, image, video, or other piece of information. In the case of images or videos, the input can be tokenized by dividing the input image or video into pixel groups. For text input, the tokens could correspond to a phrase, word, part of a word, or a single character of the text input.

Tokenization may be performed using different methods. For example, a tokenization method may generate a set of tokens to form a vocabulary for the tokens. Then, the input can be converted into tokens found in the vocabulary to represent the input. Some methods of tokenization may include Byte-Pair Encoding (BPE), Vision Transformer (ViT), and BERT for Image Transformers (BEiT). Tokenization generally helps the AI model 136 to handle different types of inputs and reduces computational costs.

At block 210, the configuration application 132 can generate a workflow description with the AI model 136 based on the tokens. Once the multi-modal input has been converted into tokens or “tokenized,” the configuration application 132 may input the tokens to the AI model 136. The AI model 136 can generate, with the tokens, a workflow description of how to perform the task requested by the user. The workflow description can embody the steps described by the user for performing the task in the multimodal input. In some examples, the workflow description includes text describing the steps to perform the task. For example, the multimodal input may depict a user filling out an electronic form with a name from a received email in the “Name” field of the form. The workflow description output by the AI model 136 may then include a text description of how to fill out the electronic form, such as “Input the email sender's name into the ‘Name’ text box of the electronic form.” If the performing the task involves multiple steps, the workflow description may be a numbered list of instructions, where the numbers indicate the order in which the instructions are to be performed. In the case that annotations are provided during configuration, the workflow description may use references of the annotations in describing the workflow. For example, rather than simply referring to a ‘Name’ text box, the description may additionally or alternatively refer to an unambiguous reference label for that text box.

At block 212, following output of the workflow description by the AI model, 138, the configuration application 132 may optionally receive configuration modification(s) from the user device 110 to the workflow description and, at block 214, configure the workflow description according to the configuration modification(s). The input application 134 may generate an interactive UI in which the user can view the workflow description and make modifications to the workflow description, such as changing an instruction, deleting an instruction, or adding an instruction. The input application 134 can then modify the workflow description according to the configuration modification(s) from the user. In this way, the user can verify that the workflow description output by the AI model 136 is correct, and if not, the user can make modifications to the workflow description. However, if the workflow description output by the AI model 136 is indeed correct, the user need not make any modifications to the workflow description. The input application 134 may then send the configured workflow to the runtime application 138 for execution.

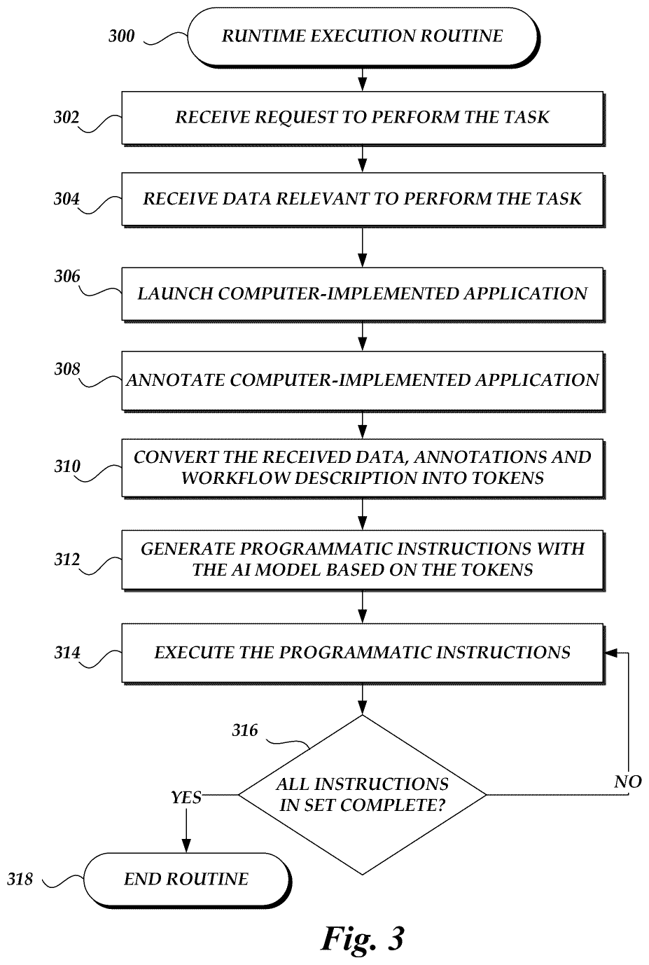

FIG. 3 illustrates an example routine 300 implemented by the runtime application 138 of the task automation system 130 for generating and implementing programmatic instructions to perform a task at runtime. The routine 300 may be embodied in a set of computer-executable instructions stored on a computer-readable medium, such as one or more disk drives of a computing system of a node or a server. When the routine 300 is initiated, the computer-executable instructions can be loaded into memory, such as random access memory (“RAM”), and executed a processor of a computing system, such as the server computing system 600 shown in FIG. 6.

At block 302, the runtime application 138 receives a request to perform the task. The request may include a request from a computing system, such as user device 110, to perform the task on an ad-hoc basis or on a routine schedule (e.g., every hour, day, or week, etc.) or may include notice of a triggering event such as described above.

At block 304, the runtime application 138 may receive new data relevant to perform the task. The new data may include data received by the user that may be used to perform the task. For example, in the form-filling example, the user may receive an email or other source of information that may contain data that can be input into the form. The new data can also originate from another data source, such as an application that may be used to perform the task or otherwise associated with performing the task.

At block 306, the runtime application 138 launches the computer-implemented application involved in performing the task. For example, if the task is performed using a web browser that includes an electronic dashboard, the runtime application 138 launches the web browser to access the dashboard and perform the task in accordance with the workflow description which may state, for example, “Access the Dashboard.” After launching the application, the runtime application 138 may take additional screenshots of the application or otherwise generate information regarding a user interface of the application. The information may be generated by an agent implemented by the task automation system 130, on the user device, or another computing system, e.g., the computing that is generating the UI interface, etc.

At block 308, the runtime application 138 annotates user interface information to provide unambiguous references for user interface elements, such as actionable items or fields detected in the user interface. For example, if the task is performed using a web browser that includes an electronic form, the runtime application 138 may annotate actionable fields in the form with unambiguous references for such fields. For example, the runtime application 138 may label each field with a reference numeral, pixel coordinates, a DOM object, or the like, such that the field can be unambiguously referred to. As described below, such unambiguous references can enable a downstream AI model, such as an LLM, to generate unambiguous machine-processable instructions to implement the task. In one embodiment, references may include programmatic references, such as a DOM object, pixel coordinates, or the like that a particular element corresponds to, and an AI model may be used to generate instructions with respect to such programmatic references. In another embodiment, references may be non-programmatic references, such as numeric labels, and the runtime application 138 may store a correspondence between non-programmatic references and a corresponding programmatic reference as determined during the annotation process. The runtime application 138 may later translate output from an AI model that includes such non-programmatic references into instructions including the programmatic references according to the stored correspondence.

As discussed above, the annotations may connect the human visual elements of the computer-implemented application with the programmatic aspects for how to interact with those visual elements of the computer-implemented application. In the web browser example, the specific programmatic elements of a webpage may be DOM elements. In order to annotate the webpage, the runtime application 138 (or agent implemented by the runtime application 138) may launch the webpage used to perform the task and take screenshots of the webpage. Then, based on the detected user interactions with the webpage identified at the configuration stage, the runtime application 138 can annotate the elements associated with the detected user interactions on the additional screenshots. The runtime application 138 may perform the annotation by using computer vision labeling tools which can identify and tag specific details (e.g., fields in the computer-implemented application) in images. The computer vision labeling tools may include a trained computer vision model that can automatically detect the location of objects in an image and label the detected objects. In one example, the annotation may include a numbered bounding box around the element. The runtime application 138 can label the element for the AI model. For example, a “Title” field on the webpage may be labeled as “DOM element 3.” The label can be used to prompt the AI model (e.g., “The user is entering the title in the field labeled three”) to generate instructions with respect to that element (e.g., “enter title in the field labeled 3”). Therefore, the annotations can establish a connection between the visual “Title” field and the programmatic “3” field in order to allow the LLM to generate the programmatic instructions.

In another example, if the task is performed using a web browser that includes an electronic dashboard, the dashboard may contain period type options for a desired analysis timeframe. The workflow description may indicate that to perform the task, a “Choose ‘Weekly’ or ‘Daily’ in the ‘Period Type’ option is to be selected, depending on the desired analysis timeframe.” The runtime application 138 can annotate (e.g., label) the fields for “Period Type” to indicate an interaction with the fields to perform the task.

At block 310, the runtime application 138 converts the received new data, annotations, and workflow description into another set of tokens, and input the tokens to the AI model 136, which in turn, in block 312, generates programmatic instructions based on the tokens. Accordingly, the programmatic instructions incorporate the annotations into the workflow description so that the runtime application 138 can execute the programmatic instructions to properly perform the task. Annotating the computer-implemented application at runtime, converting the new data, annotations and workflow description into tokens, and inputting the tokens back into the AI model 136 to generate of the programmatic instructions may ensure that the runtime application 138 properly performs the task based on the most up to date version of the computer-implemented application. In the electronic dashboard use case scenario, the programmatic instructions may include instructions to perform the analysis according to the “Period Type” now selected as “Weekly” or “Daily.”

Referring again to the form-filling use case as an example, at runtime the runtime application 138 may identify HTML elements of the webpage generated by the web browser application. For example, the form included in the webpage may contain fields, such as fields for a name, an email address, and a phone number. Therefore, the runtime application 138 can annotate the fields for name, email, and phone number to enable unambiguous identification of such fields.

Once the conversion is conducted, the runtime application 138 can input the tokens to the AI model 136. The AI model 136 may then generate and output programmatic instructions incorporating the fields. The programmatic instructions may further include instructions for extracting the data corresponding to the fields and entering the data to the fields. Accordingly, when the runtime application 138 executes the programmatic instructions, the runtime application will fill in the fields with the data extracted from the email, as indicated in the data received at block 304.

In one embodiment, the AI model 136 may generate a natural language set of instructions that can be transformed into executable instructions via a separate conversion application, as opposed to generating the executable instructions directly. In this case, the AI model 136 need not receive annotations in order to generate the set of instructions as the AI model 136 is generating natural language instructions, as opposed to programmatic instructions. The runtime application 138 can take screenshots and annotate the screenshots, as described above, and send the annotations to the separate conversion application as opposed to inputting the annotations to the AI model 136. The separate conversion application can transform the natural language instructions into specific executable instructions by linking the annotations with elements described in the natural language instructions, for example by linking DOM element labeled ‘3’ in the annotations with the “Title” field described in the natural language instructions. The conversion application can then generate the executable instructions, such as “input title into the DOM element labeled ‘3.’”

At block 314, the runtime application 138 executes the programmatic instructions to perform the task requested by the user automatically. Once it is determined in decision block 316 that all instructions in the programmatic instructions have been performed, the routine 300 ends in block 218. Otherwise, the runtime application 138 continues executing the instructions until all of the instructions have been executed. As mentioned above, if the instructions are numbered, the instructions may be executed in the order as numbered until the instruction identified by the last number is executed. In one embodiment, the runtime application 138 can feed the programmatic instructions into a screen automation system to implement the instructions.

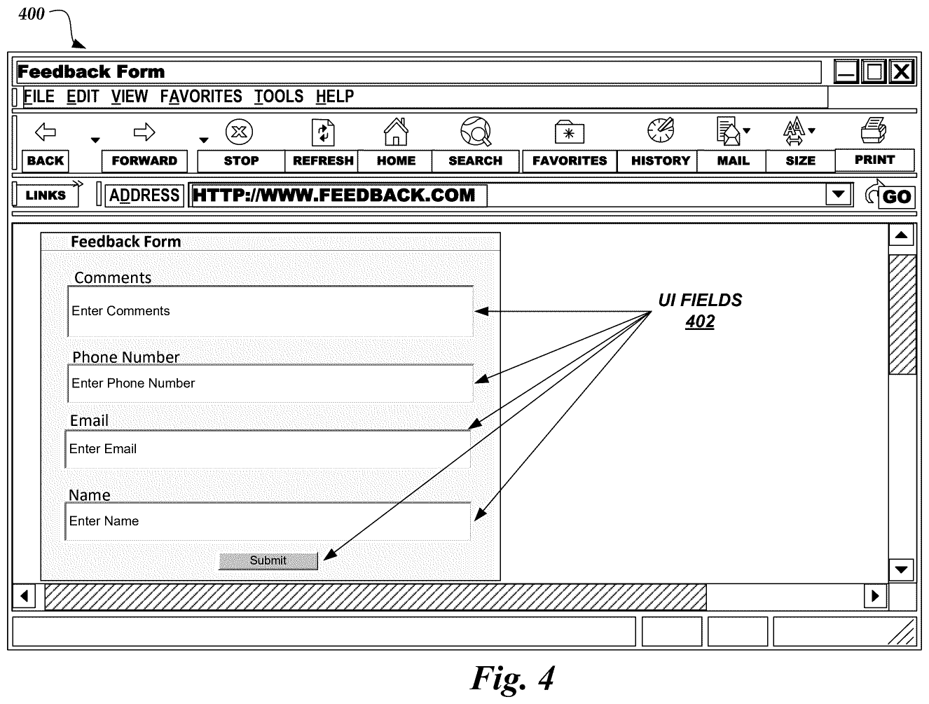

FIG. 4 illustrates an example webpage 400 including a form that is to be filled out with data obtained from an email received by the user. As mentioned above, the user may request the task automation system 130 to automate the task of filling out the form. As illustrated, the form may include a number of UI fields 402 including data entry fields and buttons. In this example, the webpage 400 is generated by a web browser and the form is a feedback form where the user may input comments, a phone number, email address, and name of a sender obtained from a feedback email received from the sender. Accordingly, the task the user wishes to automate may be to fill out the form in the webpage 400 with the comments and other data found in the email.

In order to automate the task, the user can provide the task automation system 130 with a description of the steps the user would implement in order fill out the form included in the webpage 400. As noted above, the description of the steps can be input to the task automation system by the user in a number of ways using a variety of input modalities. This multi-modal input can identify the fields 402 that the user wishes to fill out, as well as the data from the feedback email the user wishes to enter in the fields 402. As described above, the task automation system 130 converts the multi-modal input into tokens and input the tokens to an AI model in order to generate a workflow description, which the task automation system 130 utilizes at runtime to fill out the fields 402. Accordingly, when the user receives an email with feedback, the task automation system 130 launches the web browser; presents the webpage including the form; annotates the fields 402, uses the AI model to generate programmatic instructions based on the annotations, and executes the programmatic instructions to fill out the fields with the comments, phone number, email, and name it extracts from the email; and select the “Submit” button to submit the form via the web browser to a back end service for further storage and/or processing.

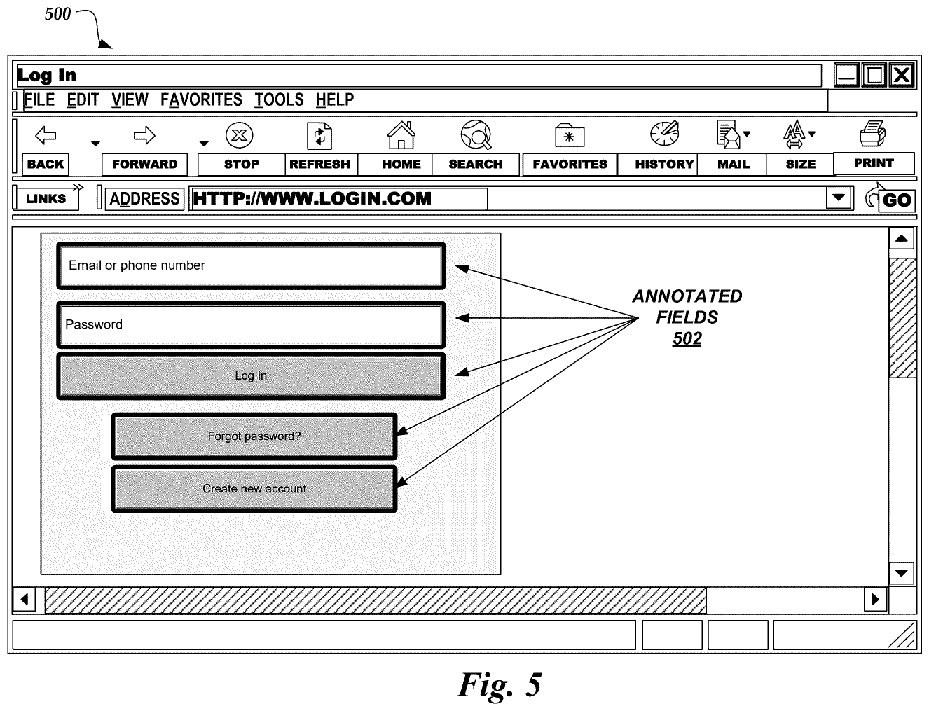

FIG. 5 illustrates an example web page 500 including a form in which fields have been added subsequent to generating the workflow description for automatically filling out the form. As noted above, the task automation system 130 may annotate fields at runtime in order to generate programmatic instructions for filling out the form. As illustrated, the form has been updated to include additional fields for identifying and authenticating the user, including an email or phone number field, a password field, and buttons with which to interact, such as a “Log In” button, a “Forgot password?” button, and a “Create new account” button. The task automation system 130 annotates the fields by labeling the new fields as depicted in FIG. 5, in addition to the fields shown in FIG. 4, and indicating an interaction with the field that is needed to perform the task. Accordingly, the task automation system 130 labels the “Email or phone number” field and indicates that the user's phone number or email is to be entered into the field; labels the “Password” field and indicates that the user's password is to be entered into the field; labels the “Log In” button and indicates that it is to be selected, and so on. The task automation system 130 can similarly label the fields of FIG. 4 and indicate the interaction with the fields of FIG. 4 that is needed to perform the task. The task automation system 130 then tokenizes the annotations and the workflow description, along with any new data received by the task automation system 130, and inputs the tokens to the AI model 136. The AI model 136 then generates and outputs programmatic instructions incorporating the annotated fields 502.

FIG. 6 depicts a general architecture of a computing device that may implement one or more of the features described herein. The general architecture of the task automation system depicted in FIG. 6 includes an arrangement of computer hardware and software that may be used to implement aspects of the present disclosure. The hardware may be implemented on physical electronic devices, as discussed in greater detail below. The task automation system may include many more (or fewer) elements than those shown in FIG. 6. It is not necessary, however, that all of these generally conventional elements be shown in order to provide an enabling disclosure. Additionally, the general architecture illustrated in FIG. 6 may be used to implement one or more of the other components illustrated in FIG. 1. As illustrated, the server computing system 600 includes a processing unit 602, a network interface 604, a computer-readable medium drive 606, and an input/output device interface 608, all of which may communicate with one another by way of a communication bus.

The network interface 604 may provide connectivity to one or more networks or computing systems. The processing unit 602 may thus receive information and instructions from other computing systems or services via the network. The processing unit 602 may also communicate to and from memory 610 and further provide output information for an optional display (not shown) via the input/output device interface 608. The input/output device interface 608 may also accept input from an optional input device (not shown).

The memory 610 may contain computer program instructions (grouped as units in some embodiments) that the processing unit 602 executes in order to implement one or more aspects of the present disclosure, along with data used to facilitate or support such execution. While shown in FIG. 6 as a single set of memory 610, memory 610 may in practice be divided into tiers, such as primary memory and secondary memory, which tiers may include (but are not limited to) random access memory (RAM), 3D XPOINT memory, flash memory, magnetic storage, and the like. For example, primary memory may be assumed for the purposes of description to represent a main working memory of the task automation system, with a higher speed but lower total capacity than a secondary memory, tertiary memory, etc.

The memory 610 may store an operating system 612 that provides computer program instructions for use by the processing unit 602 in the general administration and operation of the server computing system 600. The memory 610 may further include computer program instructions and other information for implementing aspects of the present disclosure. For example, in one embodiment, the memory 610 includes a task automation system 130.

The task automation system 130 may represent code executable to generate instructions in order to perform an automation of a requested task in a user interface, and otherwise perform the functions of the present disclosure.

The task automation system of FIG. 6 is one illustrative configuration of such a device, of which others are possible. For example, while shown as a single device, a system may in some embodiments be implemented as a logical device hosted by multiple physical host devices. In other embodiments, the task automation system may be implemented as one or more virtual devices executing on a physical computing device. While described in FIG. 6 as a server computing system 600, similar components may be utilized in some embodiments to implement other devices shown in the server computing system 600 of FIG. 6.

While certain aspects and implementations are discussed herein with reference to use of an AI model, those aspects and implementations may be performed by any type of language model, large language model (“LLM”), generative AI model, generative model, ML model, NN, multimodel model, and/or other processes. An LLM may be any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodel LLM, and/or the like. An LLM (and/or other models of the present disclosure), may include, for example, attention-based and/or transformer architecture or functionality.

A language model may be any method, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced AI method that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

In various examples, the AI models of the present disclosure may be locally hosted, cloud managed, accessed via one or more Application Programming Interfaces (“APIs”), and/or any combination of the foregoing and/or the like. Additionally, in various implementations, the AI models may be implemented in or by electronic hardware such application-specific processors (e.g., application-specific integrated circuits (“ASICs”)), AI processors, including but not limited to neural processing units (“NPUs”), programmable processors (e.g., field programmable gate arrays (“FPGAs”)), application-specific circuitry, and/or the like. Data that may be queried using the task automation systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data and/or the like, and may be stored as vectors, i.e., numerical representations of the data, in a vector database so that the data may be accurately and efficiently retrieved based on vector distance or similarity. Each vector may have number of dimensions, which can range from tens to thousands, depending on the complexity and granularity of the data.

Examples of AI models that may be used in various implementations of the present disclosure include, for example, Bidirectional Encoder Representations from Transformers (“BERT”), Language Model for Dialogue Applications (“LaMDA”), Pathways Language Model (“PaLM”), Pathways Language Model 2 (“PaLM 2”), Generative Pre-trained Transformer 2 (“GPT-2”), Generative Pre-trained Transformer 3 (“GPT-3”), Generative Pre-trained Transformer 4 (“GPT-4”), Large Language Model Meta AI (“LLaMA”), and BigScience Large Open-science Open-access Multilingual Language Model (“BLOOM”).

Although the terms machine learning and/or artificial intelligence are used herein, the scope of each term shall include each and every type of machine learning, artificial intelligence, neural network, and the like. An AI model can be built or trained based on sample data or training data in order to make predictions or decisions without being explicitly programmed to do so. In some examples, machine learning methods, models, and/or programs can perform tasks without being explicitly programmed to do so. For example, some aspects of the present disclosure may include training an AI model in a computer to carry out certain desired tasks that a human may not be able to manually perform.

A number of different types of AI methods and AI models or approaches may be used during implementation. For example, certain examples herein may use a logistical regression model, decision trees, random forests, convolutional neural networks, deep networks, or others. However, other models are possible, such as a linear regression model, a discrete choice model, or a generalized linear model. The machine learning aspects can be configured to adaptively develop and update the models over time based on new input. For example, the models can be trained, retrained, or otherwise updated on a periodic basis as newly received data is available to help keep the predictions in the model more accurate as the data is collected over time. Also, for example, the models can be trained, retrained, or otherwise updated based on configurations received from a user, admin, or other devices. Some non-limiting examples of methods that can be used to train, retrain, or otherwise update the models can include supervised, semi-supervised, and non-supervised machine learning methods, including regression methods (such as, for example, Ordinary Least Squares Regression), instance-based methods (such as, for example, Learning Vector Quantization), decision tree methods (such as, for example, classification and regression trees), Bayesian methods (such as, for example, Naive Bayes), clustering methods (such as, for example, k-means clustering), association rule learning methods (such as, for example, Apriori methods), artificial neural network methods (such as, for example, Perceptron), deep learning methods (such as, for example, Deep Boltzmann Machine), dimensionality reduction methods (such as, for example, Principal Component Analysis), ensemble methods (such as, for example, Stacked Generalization), support-vector machines, federated learning, and/or other machine learning method. These machine learning methods may include any type of machine learning method including hierarchical clustering methods and cluster analysis methods, such as a k-means method. In some cases, the performing of AI methods may include the use of an artificial neural network. By using such techniques, large amounts (such as terabytes or petabytes) of received data may be analyzed to generate or implement models with minimal, or with no, manual analysis or review by one or more people.

Additionally, depending on the example, certain acts, events, or functions of any of the processes or methods described herein can be performed in a different sequence, can be added, merged, or left out altogether (e.g., not all described operations or events are necessary for the practice of the method). Moreover, in certain examples, operations or events can be performed concurrently, e.g., through multi-threaded processing, interrupt processing, or multiple processors or processor cores or on other parallel architectures, rather than sequentially.

All of the processes described herein may be embodied in, and fully automated via, software code modules, including specific computer-readable instructions, which are executed by a computing device. The computing device may include a computer or processor. The code modules may be stored in any type of non-transitory computer-readable medium or other computer storage device. Some or all the methods may be embodied in specialized computer hardware.

Many other variations than those described herein will be apparent from this disclosure. For example, depending on the example, certain acts, events, or functions of any of the methods described herein can be performed in a different sequence, can be added, merged, or left out altogether (e.g., not all described acts or events are necessary for the practice of the methods). Moreover, in certain examples, acts or events can be performed concurrently, e.g., through multi-threaded processing, interrupt processing, or multiple processors or processor cores or on other parallel architectures, rather than sequentially. In addition, different tasks or processes can be performed by different machines and/or computing devices that can function together.

Some or all of the methods described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results and data of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm elements described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an ASIC, a FPGA, or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

Unless otherwise explicitly stated, articles such as “a” or “an” should generally be interpreted to include one or more described items throughout this application. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A system comprising:
a memory to store computer-executable instructions; and
a processor in communication with the memory, wherein the processor executes the computer-executable instructions to at least:
receive, from a requesting computing device, a request to automate a task associated with a user interface that includes a plurality of user interface elements;
receive multimodal input indicating how to perform the task associated with the user interface, wherein the multimodal input identifies individual user interface elements of the plurality of user interface elements as interacting with the user interface to perform the task associated with the user interface;
convert, into tokens, the multimodal input;
input the tokens into a large language model;
generate, with the large language model into which the tokens are input, a workflow description indicating how to perform the task associated with the user interface automatically;
receiving new input data to perform the task;
annotating the individual user interface elements of the plurality of user interface elements with a programmatic reference point for at least one user interface element that is interfaced with to perform the task associated with the user interface, wherein annotating the individual user interface elements results in annotated user interface elements;
inputting the new input data, the workflow description, and the annotated user interface elements into the large language model;
generating, with the large language model into which the new input data, the workflow description, and the annotated user interface elements are input, instructions to programmatically perform the task associated with the user interface with respect to the new input data, the instructions to programmatically perform the task including instructions to input at least a portion of the new input data into the at least one a user interface element using the programmatic reference point for the at least one user interface element; and
implementing the instructions on the individual user interface elements to perform the task associated with the user interface automatically.

2. The system of claim 1, wherein the processor executes further computer-executable instructions to at least:
receive a modification to the workflow description from the requesting computing device; and
configure the workflow description with the modification, wherein the workflow description that is input to the large language model comprises the workflow description configured with the modification.

3. The system of claim 1, wherein the request is generated by the requesting computing device or a triggering event.

4. The system of claim 1, wherein the user interface comprises a form and the task comprises completing the form with text from another source.

5. The system of claim 1, wherein the multimodal input comprises at least one of a screen recording, audio narration, or text.

6. The system of claim 1, wherein the workflow description comprises a text description of how to perform the task associated with the user interface.

7. A computer-implemented method comprising:
receiving input indicating how to perform a task associated with a user interface;
generating, using an artificial intelligence (AI) model and from the input, a workflow description of how to perform the task with the user interface;
receiving new input data associated with performance of the task;
annotating information of the user interface with a reference point for at least one user interface element that is interfaced with to perform the task, wherein annotating the information results in annotated user interface information;
inputting the new input data, the workflow description, and the annotated user interface information into the AI model;
generating, with the AI model, executable instructions to programmatically perform the task associated with the user interface with respect to the new input data, the instructions to programmatically perform the task including instructions to input at least a portion of the new input data into the at least one a user interface element using the reference point for the at least one user interface element; and
implementing the instructions to perform the task with the user interface automatically.

8. The computer-implemented method of claim 7, wherein the input comprises at least one of a screen recording, audio narration, or text.

9. The computer-implemented method of claim 7, wherein the instructions comprise a programmatic description of how to perform the task.

10. The computer-implemented method of claim 7, wherein annotating information of the user interface comprises labeling the reference point as a programmatic reference with which a particular element corresponds.

11. The computer-implemented method of claim 7, further comprising:
receiving, from a computing device, a modification to the workflow description; and
configuring the workflow description with the modification received from the computing device to form a configured workflow description.

12. The computer-implemented method of claim 7, wherein the reference point comprises one or more of: a reference numeral, pixel coordinates, or a DOM object.

13. The computer-implemented method of claim 12, wherein the user interface comprises a computer-implemented form and wherein the workflow description comprises instructions to fill out the computer-implemented form with data extracted from another source.

14. One or more non-transitory computer-readable media storing specific computer-executable instructions that, when executed by a processor, cause the processor to at least:
receive a request to implement a workflow description to automatically perform a manual task associated with a user interface that includes a plurality of user interface elements;
launch the user interface;
annotate information of the user interface with a reference point for at least one user interface element that is interfaced with to perform the task, wherein annotating the information results in annotated user interface information;
input the annotated user interface information and the workflow description to perform the manual task to an artificial intelligence model trained to generate, from the annotated user interface information and the workflow description, instructions to programmatically perform the manual task, the instructions to programmatically perform the task including instructions to interact with the at least one a user interface element using the reference point for the at least one user interface element;
generate, with the artificial intelligence model, the programmatic instructions to perform the manual task; and
implement the instructions to automatically perform the manual task with the user interface.

15. The one or more non-transitory computer-readable media of claim 14, wherein the request is generated by a requesting computing device or a triggering event.

16. The one or more non-transitory computer-readable media of claim 15, wherein the one or more non-transitory computer-readable media stores further specific computer-executable instructions that, when executed by the processor, cause the processor to at least receive new input data to perform the task, wherein the new input data is input, with the annotated user interface elements and the workflow description, to the artificial intelligence model to generate the executable instructions.

17. The one or more non-transitory computer-readable media of claim 14, wherein to annotate the information of the user interface, the one or more non-transitory computer-readable media stores further specific computer-executable instructions that, when executed by the processor, cause the processor to at least label the at least one user interface element with the reference point.

18. The one or more non-transitory computer-readable media of claim 14, wherein the user interface comprises a form and the task comprises completing the form with text from another source.

19. The one or more non-transitory computer-readable media of claim 18, wherein the workflow description comprises a textual description of how complete the form with the text.

20. The one or more non-transitory computer-readable media of claim 14, wherein to input the annotated user interface elements and the workflow description to perform the manual task to the artificial intelligence model, the one or more non-transitory computer-readable media stores further specific computer-executable instructions that, when executed by the processor, cause the processor to at least convert the annotated user interface elements and the workflow description into tokens and input the tokens to the artificial intelligence model.
